(19) United States
(12) Patent Application Publication
(10) Pub. No.: US 2004/0021401 A1
(43) Pub. Date: Feb. 5, 2004

(54) Method for producing crystal growth substrate and semiconductor light-emitting element

(75) Inventor: Masanobu Ando, Nishikasugai-gun (JP)

Correspondence Address: McGinn & Gibb, PLLC, Suite 200, 8321 Old Courthouse Road, Vienna, VA, 22182-3817, US

(73) Assignee: Toyoda Gosei Co., Ltd., Nishikasugai-gun (JP)

(21) Appl. No.: 10/628,492

(22) Filed: Jul. 29, 2003

(30) Foreign Application Priority Data
Jul. 30, 2002 (JP) P2002-220564

(51) Int. Cl. H02N 2/00

(52) U.S. Cl. 310/344

(57) ABSTRACT

When sapphire is epitaxially grown on a seed substrate of Si at a growth temperature of about 350° C. by an ionized cluster beam vapor deposition and epitaxy method, a γ phase Al₂O₃ layer is formed. When the γ phase Al₂O₃ layer is exposed to a high temperature of not lower than 1000° C., the γ phase Al₂O₃ layer then changes to an α phase Al₂O₃ layer by phase transition. A known or optional semiconductor light-emitting element can be formed on the α phase sapphire. When the seed substrate of Si is then selectively removed by etching, a semiconductor light-emitting element having a light-extracting surface of the sapphire processed into a desired shape can be obtained. As a result, external quantum efficiency of the semiconductor light-emitting element can be improved as well as light-condensing characteristic and directivity of light output from the semiconductor light-emitting element can be improved.

The present application is based on Japanese Patent Application No. 2002-220564, which is incorporated herein by reference.

### BACKGROUND OF THE INVENTION

1. Field of the Invention

The present invention relates to a method for producing a crystal growth substrate and a semiconductor light-emitting element.

The invention is particularly useful for production of a semiconductor light-emitting element capable of emitting planar light and including a semiconductor laminated on a sapphire substrate by crystal growth.

2. Description of the Related Art

In a related-art crystal growth substrate for semiconductor light-emitting element formed on a sapphire substrate, both upper and lower surfaces of the substrate have flatness of the mirror surface level. A certain degree of thickness is required of the substrate in order to provide durability against external force and temperature change to thereby stabilize the process of production. In the present circumstances, the crystal growth step and steps after that are performed by use of a sapphire substrate having a thickness of not smaller than 100 μm.

When a sapphire substrate having a thickness of not smaller than 100 μm is used as the crystal growth substrate for semiconductor light-emitting element, the following problems however occur.

(Problem 1)

As the condition for carrying out the separation step of separating the sapphire substrate, the sapphire substrate must be sufficiently thinner than 100 μm. Therefore, the step (polishing step) of reducing the thickness of the sapphire substrate needs to be carried out before the separation step of separating the sapphire substrate is carried out. With interposition of the polishing step, quality, yield, production efficiency, etc. may be worsened.

When, for example, the state of polishing is roughened in the polishing step, the loss of light occurs in the polished surface so that external quantum efficiency of the semiconductor light-emitting element is reduced. Conversely, high production cost is required for making the polishing state sufficiently fine in the polishing step.

(Problem 2)

The sapphire substrate is very rigid so that processing such as grinding cannot be easily applied to the sapphire substrate. Accordingly, it is very difficult to process the shape of the rear surface of the sapphire substrate in order to improve efficiency in extracting light to the polished surface (rear surface) located on the rear side of the crystal growth surface (i.e., external quantum efficiency of the semiconductor light-emitting element), light-condensing characteristic, light directivity, etc.

### SUMMARY OF THE INVENTION

The invention is developed to solve the problems and an object of the invention is to provide a novel molding technique concerning the shape of a rear surface of a semiconductor crystal growth substrate (sapphire substrate) to thereby improve external quantum efficiency of a semiconductor light-emitting element, light-condensing characteristic, light directivity, etc.

The following means is effective in solving the problems.

That is, as first means of the invention, there is provided a method of producing a sapphire substrate capable of being used as a semiconductor crystal growth substrate, the method including: the seed substrate molding step of molding a seed substrate into a desired shape so that irregularities are provided to a sapphire growth surface of the seed substrate; the sapphire substrate growth step of growing a sapphire crystal on the sapphire growth surface of the seed substrate to thereby form a sapphire substrate; and the seed substrate removal step of removing the seed substrate selectively from the sapphire substrate formed by the sapphire substrate growth step.

When the seed substrate is capable of being etched more easily than sapphire (Al₂O₃), it can be subjected to surface processing easily, and an optional surface shape of the seed substrate can be achieved. Accordingly, when the seed substrate is used as a mold, the sapphire thin-film layer subsequently grown as a crystal on the seed substrate can be likewise formed into an optional shape though the shape of the irregularities of the sapphire thin-film layer is reverse to the shape of the irregularities of the seed substrate.

Accordingly, for example, molding can be performed easily so that a large number of microlens-shaped convex portions are arranged in a rear surface of the sapphire substrate. That is, according to the method, the shape of the rear surface of the sapphire substrate can be processed into a preferred or desired shape. Accordingly, when the sapphire substrate is used, external quantum efficiency of the semiconductor light-emitting element, light-condensing characteristic, light directivity, etc. can be improved.

As second means of the invention, in the first means, silicon (Si) or gallium arsenide (GaAs) is used as the material of the seed substrate.

These materials are relatively easy to process finely and can be etched more easily than sapphire (Al₂O₃). Accordingly, the producing method can be performed easily.

As third means of the invention, chemical etching is performed in the seed substrate removal step defined in the first or second means.

In the seed substrate removal step, a silicon substrate or the like can be removed by an optional method. For example, stress based on the difference in thermal expansion coefficient in the crystal growth surface may be used for peeling the seed substrate 200 to thereby remove the seed substrate 200. Preferably, a method of chemical etching (selective etching) by which nitride semiconductors, electrodes, etc. can hardly be eroded may be used so that selective etching can be performed with higher accuracy.

As fourth means of the invention, in any one of the first to third means, there is further provided the phase transition step of heating the sapphire substrate formed by the sapphire substrate growth step at a high temperature of not lower than about 1000° C. to thereby perform phase transition of the sapphire substrate from γ phase to α phase.

By this means, the sapphire substrate grown on the seed substrate may be of γ phase during the growth. Accordingly, when the sapphire substrate is grown as a crystal, any convenient crystal growth method can be selected from a broad range of crystal growth methods.

As fifth means of the invention, the shape of the irregularities provided to the sapphire growth surface of the seed substrate is formed by use of cavities each having part of an almost spherical shape in the seed substrate molding step defined in any one of the first to fourth means.

By this means, microlens-shaped convex portions can be provided in the rear surface (light-extracting surface) of the sapphire substrate.

As sixth means of the invention, cavities are formed periodically so as to be arranged two-dimensionally in the sapphire growth surface of the seed substrate in the seed substrate molding step defined in any one of the first to fifth means.

By this means, microlens-shaped convex portions can be efficiently arranged in the rear surface (light-extracting surface) of the sapphire substrate. The method of arrangement is not limited to a method of arrangement based on squares, equilateral triangles, etc. Any arrangement method may be used.

As seventh means of the invention, there is provided a method of producing a semiconductor light-emitting element, the semiconductor light-emitting being capable of emitting planar light and including a semiconductor laminated on a sapphire substrate by crystal growth, the method including: the seed substrate molding step, the sapphire substrate growth step and the seed substrate removal step defined in a method of producing a crystal growth substrate according to any one of the first to sixth means; and the semiconductor crystal growth step of growing a desired semiconductor layer as a crystal on the sapphire substrate, the step being provided between the sapphire substrate growth step and the seed substrate removal step.

According to this means, the seed substrate removal step can be performed in the condition that a desired semiconductor layer has been grown as a crystal on the sapphire substrate, so that the sapphire substrate is hardly broken when the seed substrate removal step is performed. Accordingly, the sapphire substrate can be made thinner, so that external quantum efficiency of the semiconductor light-emitting element capable of emitting planar light is improved.

As eighth means of the invention, in the seventh means, there is further provided the electrode formation step of forming an electrode, the step being provided between the semiconductor crystal growth step and the seed substrate removal step.

That is, positive and negative electrodes of the semiconductor light-emitting element capable of emitting planar light may be formed before or after the seed substrate removal step.

As ninth means of the invention, in the seventh or eighth means, the semiconductor layer is made of a Group III nitride compound semiconductor containing “AlₓGa_{y}In_{1-x-y}N (0≦x≦1, 0≦y≦1, 0≦x+y≦1)” as a main component, which may contain impurities as an additive or may be free from impurities.

As tenth means of the invention, there is provided a semiconductor light-emitting element capable of emitting planar light and including a semiconductor laminated on a sapphire substrate by crystal growth, wherein any one of the seventh to ninth means is used so that a rear surface (light-extracting surface) of the sapphire substrate is formed into a shape reverse to the shape of the irregularities provided to the sapphire growth surface of the seed substrate used as a mold.

As eleventh means of the invention, there is provided a sapphire substrate capable of being used as a semiconductor crystal growth substrate, wherein any one of the first to sixth means is used so that a rear surface of the sapphire substrate is formed into a shape reverse to the shape of the irregularities provided to the sapphire growth surface of the seed substrate used as a mold.

Incidentally, the semiconductor material of the semiconductor light-emitting element is not particularly limited t a narrow range. When, for example, the semiconductor light-emitting element includes Group III nitride compound semiconductors, respective semiconductor layers to be formed can be made of Group III nitride compound semiconductors such as binary, ternary or quaternary semiconductors at least represented by AlₓGa_{y}In_{1-x-y}N (0≦x≦1, 0≦y≦1, 0≦x+y≦1). The Group III elements may be partially replaced by boron (B), thallium (Tl), etc. The nitrogen (N) may be partially replaced by phosphorus (P), arsenic (As), antimony (Sb), bismuth (Bi), etc.

When these semiconductors are used for forming n-type Group III nitride compound semiconductor layers, Si, Ge, Se, Te, C, etc. may be added as n-type impurities. When these semiconductors are used for forming p-type Group III nitride compound semiconductor layers, Zn, Mg, Be, Ca, Sr, Ba, etc. may be added as p-type impurities.

As methods for growing these semiconductor layers as crystals, there are effective methods such as a molecular beam epitaxy method (MBE), a metal organic chemical vapor deposition method (MOCVD), a halide vapor phase epitaxy method (HVPE), and a liquid phase epitaxy method.

To improve light-reflecting efficiency, a metal such as Al, In, Cu, Ag, Pt, Ir, Pd, Rh, W, Mo, Ti or Ni or an alloy containing at least one kind of metal selected from these metals can be used to form a light-reflecting metal film.

By the means of the invention, the problems can be solved effectively or reasonably.

### BRIEF DESCRIPTION OF THE DRAWINGS

In the accompanying drawings:

FIG. 1A is a perspective view of a semiconductor light-emitting element 100 with a crystal growth substrate having a lower surface (principal surface 1) processed into an optional shape; and FIG. 1B is a plan view of the semiconductor light-emitting element 100;

FIG. 2 is a view of state transition showing (a first half of) a process for producing the semiconductor light-emitting element 100; and

FIG. 3 is a view of state transition showing (a second half of) the process for producing the semiconductor light-emitting element 100.

### DETAILED DESCRIPTION OF THE PREFERRED EMBODIMENTS

The invention will be described below in connection with a specific embodiment thereof. Incidentally, the invention is not limited to the following embodiment.

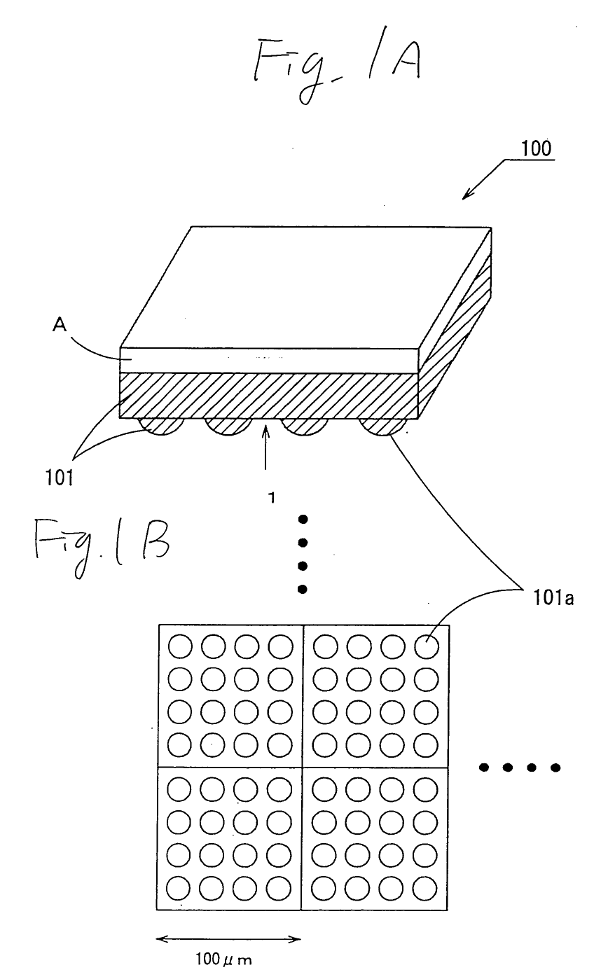

In this embodiment, a procedure for forming a nitride compound semiconductor on sapphire 101 formed (by crystal growth) on a substrate capable of being etched easily. FIG. 1A is a perspective view of a semiconductor light-emitting element 100 including a crystal growth substrate having a lower surface (principal surface 1) processed into a desired shape. FIG. 1B is a plan view of the semiconductor light-emitting element 100. The semiconductor light-emitting element 100 forms a main portion of a flip chip type planar-emission LED. Approximately hemispherical convex portions 101a are two-dimensionally arranged periodically in the light-extracting surface (principal surface 1) of the sapphire 101. A surface opposite to the light-extracting surface (principal surface 1) forms a crystal growth surface for a semiconductor crystal (semiconductor multilayer A). The semiconductor multilayer A is grown on the crystal growth surface.

Next, description will be mainly given to a method for processing the shape of the lower surface (principal surface 1).

For example, a silicon (Si) substrate, or a gallium arsenide (GaAs) substrate can be used as the substrate capable of being etched easily. When, for example, a silicon (Si) substrate is used, a (100) face or a (110) face may be preferably used as the crystal growth surface.

Before the sapphire 101 is grown on the crystal growth surface (the (100) face or the (110) face) of the silicon substrate 200, the crystal growth surface is subjected to the following etching process as a process of preparation for achieving the desired shape.

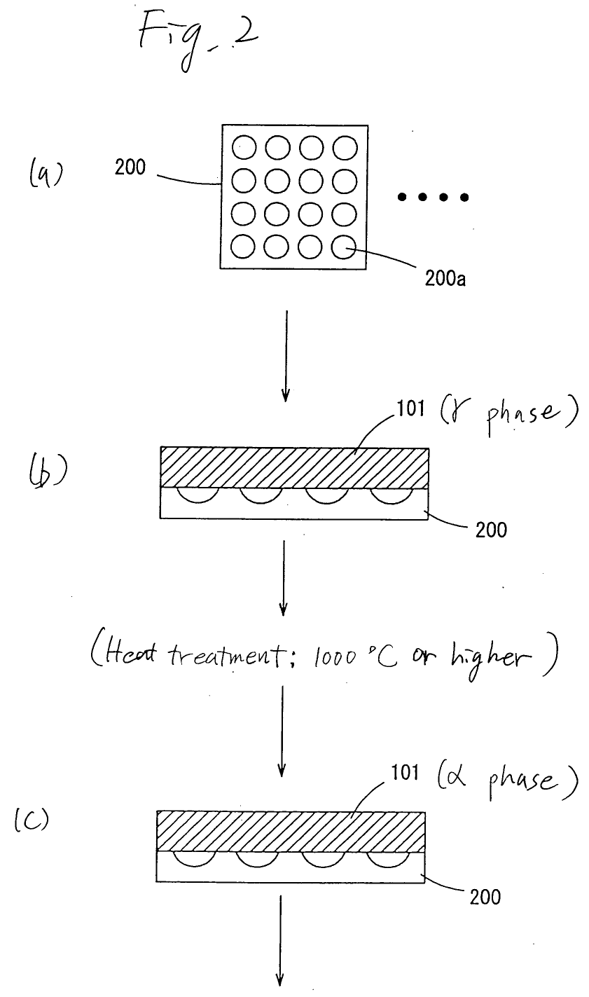

That is, for example, as shown in step (a) of FIG. 2, cavities (concave portions 200a) each having a suitable curvature radius are formed periodically on the basis of a desired element size (e.g., 100 μm square). Because the silicon substrate 200 finally functions as a mold, a large number of convex lenses (microlenses 101a) can be arranged in the light-extracting surface (principle surface 1 in FIG. 1A) of a sapphire intermediate layer as an array according to the desired element size due to the preparatory process.

The processed silicon substrate (seed substrate 200) is used so that sapphire (Al₂O₃) 101 is epitaxially grown on the silicon substrate 200. Any method may be used as the crystal growth method.

FIG. 2 shows steps (a) to (c) of a procedure (production process) for epitaxially growing sapphire (Al₂O₃) 101.

When, for example, sapphire (Al₂O₃) 101 is epitaxially grown at a growth temperature of about 350° C. by an ionized cluster beam vapor deposition and epitaxy method, an Al₂O₃ layer of γ phase is formed. When the Al₂O₃ layer of γ phase is exposed to a high temperature of not lower than 1000° C., the Al₂O₃ layer of γ phase changes to the Al₂O₃ layer of α phase by phase transition.

On the α phase Al₂O₃ substrate (sapphire 101) obtained by the aforementioned process, a known- or optional-form semiconductor light-emitting element (e.g., a flip chip type planar-emission semiconductor light-emitting element) can be formed by a known or optional epitaxial growth method.

For example, forms described in Unexamined Japanese Patent Publication No. 2000-036619: Group III Nitride Compound Semiconductor Light-Emitting Element, Unexamined Japanese Patent Publication No. 2000-183400: Group III Nitride Compound Semiconductor Light-Emitting Element, Unexamined Japanese Patent Publication No. Hei-11-220168: Gallium Nitride Compound Semiconductor Element and Method for Producing the Same, Unexamined Japanese Patent Publication No. Hei-11-220171: Gallium Nitride Compound Semiconductor Element”, etc. are generally and widely known as known forms for formation of a semiconductor light-emitting element on a sapphire substrate (i.e., α phase Al₂O₃ substrate).

More specifically, for example, the semiconductor mutlilayer A can be obtained as a laminate of an AlN buffer layer, an n-type GaN layer, a light-emitting layer, a p-type AlGaN layer, a p-type GaN layer, etc. successively grown as crystals on the sapphire substrate. The light-emitting layer may be of an MQW structure or of an SQW structure. The semiconductor multilayer A can be laminated as a known or optional structure by any crystal growth method. Electrodes can be also formed as a known or optional structure.

That is, for example, a semiconductor light-emitting element having a known or optional structure as described above can be formed on the α phase Al₂O₃ substrate (sapphire intermediate layer) 101 obtained by the aforementioned process. Incidentally, the semiconductor light-emitting element formed is a flip chip type planar-emission semiconductor light-emitting element.

Alternatively, the semiconductor light-emitting element formed on the α phase Al₂O₃ substrate (sapphire intermediate layer) 101 obtained by the aforementioned process may be an LED or a semiconductor laser.

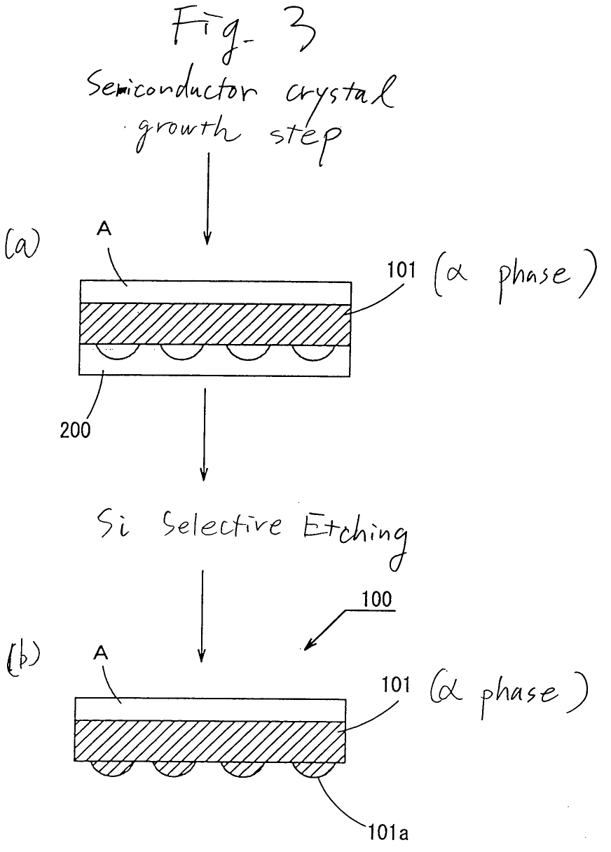

After all the steps of the process are completed, the seed substrate removal step for removing only the silicon substrate serving as an initial seed for crystal growth is carried out. Steps (a) and (b) of FIG. 3 show the outline of the seed substrate removal step. Any method may be used for removing the silicon substrate in the seed substrate removal step. Preferably, an etching method (Si selective etching) in which nitride compound semiconductors, electrodes, etc. are little eroded may be used. Or stress based on the difference in thermal expansion coefficient in the crystal growth surface may be used for peeling the seed substrate 200 to thereby remove the seed substrate 200.

By these steps, a semiconductor light-emitting element including a sapphire substrate 101 having a rear surface (light-extracting surface) processed into a desired shape can be obtained.

For example, by the procedure, external quantum efficiency of the semiconductor light-emitting element can be improved as well as condensing characteristic and directivity of light (planar-emitted light) released from the light-extracting surface (principal surface 1 in FIG. 1A) can be improved.

The invention is not limited to the embodiment and various modifications maybe conceived. Although a GaN semiconductor layer is used as a Group III nitride compound semiconductor, it is a matter of course that a layer of GaₓIn₁₋ₓN (e.g., Ga_{0.08}In_{0.92}N) or ternary or quaternary semiconductor of an optional mixed crystal ratio such as AlGaInN may be used. More specifically, ternary Group III nitride compound semiconductors (GaInN, AlInN, and AlGaN) or quaternary Group III nitride compound semiconductor (AlGaInN) represented by the general formula “AlₓGa_{y}In_{1-x-y}N (0≦x≦1, 0≦y≦1, 0≦x+y≦1)” may be used. In these compounds, the nitrogen (N) may be partially replaced by a Group V element such as P or As.

When, for example, a Group III nitride compound semiconductor is laminated on the sapphire substrate, a buffer layer is preferably formed to correct lattice mismatching with the sapphire substrate to thereby form the Group III nitride compound semiconductor with good crystallinity. Also when another substrate is used, such a buffer layer is preferably provided. Preferably, the buffer layer is made of a Group III nitride compound semiconductor formed at a low temperature and represented by AlₓGa_{y}In_{1-x-y}N (0≦x≦1, 0≦y≦1, 0≦x+y≦1). Further preferably, the buffer layer is made of a Group III nitride compound semiconductor represented by AlₓGa₁₋ₓN (0≦x≦1).

The buffer layer may be provided as a single layer or as a laminate of layers different in composition. As a method for forming the buffer layer, a low temperature of 300° C. to 500° C. may be used for forming the buffer layer. Or a temperature range of from 1000° C. to 1100° C. may be used for forming the buffer layer by an MOCVD method.

Or a DC magnetron sputtering apparatus may be used for forming the buffer layer of AlN by a reactive sputtering method with high-purity metallic aluminum and nitrogen gas used as raw materials. The buffer layer of a compound represented by the general formula AlₓGa_{y}In_{1-x-y}N (0≦x≦1, 0≦y≦1, 0≦x+y≦1, compounding ratio: optional) may be formed in the same manner as described above. Further, a vapor deposition method, an ion-plating method, a laser ablation method or an ECR method may be used. When the buffer layer is formed by a physical vapor deposition method, the buffer layer may be preferably formed at a temperature of 200° C. to 600° C.

More preferably, the temperature is in a range of from 300° C. to 600° C. Further preferably, the temperature is in a range of from 350° C. to 450° C. When these physical vapor deposition methods such as a sputtering method are used, the thickness of the buffer layer is preferably in a range of from 100 Å to 3000 Å, more preferably in a range of from 100 Å to 400 Å, most preferably in a range of from 100 Å to 300 Å. As a method for forming a multilayer, for example, layers of AlₓGa₁₋ₓN (0≦x≦1) and layers of GaN may be formed alternately.

It is a matter of course that the aforementioned methods may be combined and the multilayer may be made of a laminate of three or more kinds of Group III nitride compound semiconductors represented by AlₓGa_{y}In_{1-x-y}N (0≦x≦1, 0≦y≦1, 0≦x+y≦1). Generally, the buffer layer is amorphous and the Group III nitride compound semiconductor layer formed on the buffer layer is monocrstalline. A plurality of periods each containing the buffer layer and the single crystal Group III nitride compound semiconductor layer may be formed. In this case, the number of repeated periods may be optional.

Alternatively, a high-temperature buffer layer may be formed on a low-temperature buffer layer before the Group III nitride compound semiconductor as a main body is formed on the high-temperature buffer layer.

Even in the case where the Group III elements contained in the compositions of the buffer layer and the Group III nitride compound semiconductor layer formed on the buffer layer may be partially replaced by boron (B), thallium (Tl), etc., or the nitrogen (N) contained in the compositions may be partially replaced by phosphorus (P), arsenic (As), antimony (Sb), bismuth (Bi), etc., the invention can be substantially applied. In addition, each of these elements may be doped with such a small amount of impurities that cannot be indicated in composition.

For example, AlₓGa₁₋ₓN (0≦x≦1) which is a Group III nitride compound semiconductor containing neither indium (In) nor arsenic (As) in composition may be doped with indium (In) larger in atomic radius than aluminum (Al)/gallium (Ga) and with arsenic (As) larger in atomic radius than nitrogen (N) so that expanding distortion of crystal due to nitrogen atom missing can be compensated with contracting distortion to thereby improve crystallinity. In this case, because acceptor impurities can enter the position of Group III atoms easily, a p-type crystal can be obtained as grown.

When buffer layers and Group III nitride compound semiconductor layers are formed at two or more periods, each of the Group III nitride compound semiconductor layers may be preferably doped with an element larger in atomic radius than the main constituent element of the layer. Incidentally, when a light-emitting element is formed, binary or ternary Group III nitride compound semiconductors may be essentially preferably used.

When an n-type Group III nitride compound semiconductor layer is formed, a Group IV or Group VI element such as Si, Ge, Se, Te, or C may be added as n-type impurities. When a p-type Group III nitride compound semiconductor layer is formed, a Group II or Group IV element such as Zn, Mg, Be, Ca, Sr, or Ba may be added as p-type impurities. One layer may be doped with a plurality of elements or may be doped with n-type impurities and p-type impurities simultaneously.

When a GaN semiconductor doped with Mg while injected with boron is heated at 1100° C. for 60 seconds, hole density changes from 5.5×10¹⁶/cm³ to 8.1×10¹⁹/cm³. By injection of boron, the activation energy of magnesium is reduced to 170 mV. It is conceived that this is because boron loosens the bond between magnesium and hydrogen and bonds to hydrogen. Accordingly, it is preferable that boron is injected together with acceptor impurities such as magnesium in order to obtain a p-type layer.

In the configuration of each layer, horizontal epitaxial growth may be used optionally for reducing the dislocation of the Group III nitride compound semiconductor layer. In this case, a method using a mask may be used, or a method in which a level difference is formed so that a horizontally grown layer is formed above the concave portions without use of any mask may be used. As the method using the level difference, there may be used a method in which spot-shaped or striped concave portions are formed on a substrate so that a Group III nitride compound semiconductor is grown on the concave portions and horizontally grown above the concave portions.

An air gap may be formed between the horizontally grown layer and a layer or substrate below the horizontally grown layer. When an air gap is formed, crystallinity can be improved more greatly because stress strain can be prevented. As the condition for growing crystal horizontally, there are a method for increasing the temperature, a method for increasing the amount of supplied Group III element gas and a method for adding magnesium (Mg).

Although a metal organic chemical vapor deposition method (MOCVD) or a metal organic vapor phase epitaxy method (MOVPE) is preferably used as a method for forming a Group III nitride compound semiconductor layer, another method such as a molecular beam epitaxy method (MBE), a halide vapor phase epitaxy method (halide VPE), or a liquid phase epitaxy method (LPE) may be used. Layers may be formed by different methods respectively.

The present invention is not limited to the mode for carrying out the invention and the embodiment thereof at all, and includes various modifications which can be conceived easily by those skilled in the art, without departing from the scope of claim.

What is claimed is:

1. A method of producing a crystal growth substrate, comprising:
molding a seed substrate into a desired shape so that irregularities are provided to a sapphire growth surface of said seed substrate;
growing a sapphire crystal on said sapphire growth surface of said seed substrate to thereby form a sapphire substrate; and
removing said seed substrate selectively from said sapphire substrate formed by the sapphire substrate growth step.

2. A method of producing a crystal growth substrate according to claim 1, wherein silicon (Si) or gallium arsenide (GaAs) is used as a material of said seed substrate.

3. A method of producing a crystal growth substrate according to claim 1, wherein chemical etching is performed in the seed substrate removal step.

4. A method of producing a crystal growth substrate according to claim 1, further comprising a step of heating said sapphire substrate formed by the sapphire substrate growth step at a high temperature of not lower than about 1000° C. to thereby perform phase transition of said sapphire substrate from γ phase to α phase.

5. A method of producing a crystal growth substrate according to claim 1, wherein the shape of said irregularities provided to said sapphire growth surface of said seed substrate is formed by use of cavities each having part of an almost spherical shape in the seed substrate molding step.

6. A method of producing a crystal growth substrate according to claim 1, wherein cavities are formed periodically so as to be arranged two-dimensionally in said sapphire growth surface of said seed substrate in the seed substrate molding step.

7. A method of producing a semiconductor light-emitting element, said semiconductor light-emitting element capable of emitting planar light and including a semiconductor laminated on a sapphire substrate by crystal growth, said method comprising:
molding a seed substrate into a desired shape so that irregularities are provided to a sapphire growth surface of said seed substrate;
growing a sapphire crystal on said sapphire growth surface of said seed substrate to thereby form a sapphire substrate;
growing a desired semiconductor layer as a crystal on said sapphire substrate; and
removing said seed substrate selectively from said sapphire substrate formed by the sapphire substrate growth step.

8. A method of producing a semiconductor light-emitting element according to claim 7, further comprising a step of forming an electrode, the step being provided between the semiconductor crystal growth step and the seed substrate removal step.

9. A method of producing a semiconductor light-emitting element according to claim 7, wherein said semiconductor layer is made of a Group III nitride compound semiconductor containing “AlₓGa_{y}In_{1-x-y}N (0≦x≦1, 0≦y≦1, 0≦x+y≦1)” as a main component, which may contain impurities as an additive or may be free from impurities.

10. A semiconductor light-emitting element capable of emitting planar light and including a semiconductor laminated on a sapphire substrate by crystal growth, wherein:
said semiconductor light-emitting element is produced by a method of producing a semiconductor light-emitting element according to claim 7; and
a rear surface of said sapphire substrate is formed into a shape reverse to the shape of said irregularities provided to said sapphire growth surface of said seed substrate used as a mold.

11. A sapphire substrate capable of being used as a semiconductor crystal growth substrate, wherein:
said sapphire substrate is produced by a method of producing a crystal growth substrate according to claim 1; and
a rear surface of said sapphire substrate is formed into a shape reverse to the shape of said irregularities provided to said sapphire growth surface of said seed substrate used as a mold.

12. A method of producing a crystal growth substrate according to claim 1, wherein said seed substrate is capable of being etched more easily than sapphire (Al₂O₃).

13. A method of producing a semiconductor light-emitting element according to claim 7, wherein said seed substrate is capable of being etched more easily than sapphire (Al₂O₃).
